(19) United States
(12) Patent Application Publication
(10) Pub. No.: US 2007/0138410 A1
(43) Pub. Date: Jun. 21, 2007

(54) Gas barrier film, method of producing the same and stimulable phosphor panel

(75) Inventors: Takeo Kido, Kanagawa (JP); Makoto Kashiwaya, Kanagawa (JP); Junji Nakada, Shizuoka (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Minato-ku (JP)

(21) Appl. No.: 11/640,995

(22) Filed: Dec. 19, 2006

(30) Foreign Application Priority Data
Dec. 20, 2005 (JP) 2005-365838

(51) Int. Cl. G01J 1/58; G01N 21/64; G01T 1/00

(52) U.S. Cl. 250/483.1; 250/484.4

(57) ABSTRACT

A gas barrier film includes a substrate film and a gas barrier layer formed on the substrate film. The gas barrier layer is an inorganic compound layer that is made of an inorganic compound having a grain size of 3 nm to 20 nm and has grain boundaries at intervals of 1 nm to 20 nm. A stimulable phosphor panel includes a substrate, a stimulable phosphor layer formed on the substrate and the gas barrier film with which the stimulable phosphor layer is covered and sealed. A gas barrier film producing method prepares the substrate film and performs impedance controlled reactive sputtering on the substrate film at a film deposition pressure of 0.01 Pa to 0.13 Pa to form the gas barrier layer on the substrate film to thereby produce the gas barrier film.

The entire contents of documents cited in this specification are incorporated herein by reference.

### BACKGROUND OF THE INVENTION

The present invention belongs to a technical field of gas barrier films and their production methods, and stimulable phosphor panels. More specifically, the invention relates to a gas barrier film that is the most appropriate as a moisture-proof protective film for sealing a stimulable phosphor layer of a stimulable phosphor panel, its production method, and the stimulable phosphor panel that uses the gas barrier film.

Upon exposure to a radiation (e.g. X-rays, α-rays, β-rays, γ-rays, electron beams, and ultraviolet rays), certain types of phosphors known in the art accumulate part of the energy of the applied radiation and, in response to subsequent application of excitation light such as visible light, they emit photostimulated luminescence in an amount that is associated with the accumulated energy. Called “storage phosphors” or “stimulable phosphors”, those types of phosphors find use in medical and various other fields.

A known example of such use is a radiation image information recording and reproducing system that employs a stimulable phosphor panel having a film (or layer) of the stimulable phosphor (which is hereinafter referred to as a phosphor layer). The stimulable phosphor panel is hereinafter referred to simply as the phosphor panel and is also called the radiation image conversion sheet. The system has already been commercialized by, for example, Fuji Photo Film Co., Ltd. under the trade name of FCR (Fuji Computed Radiography).

In that system, a subject such as a human body is irradiated with X-rays or the like to record radiation image information about the subject on the phosphor panel (more specifically, the phosphor layer). After the radiation image information is thus recorded, the phosphor panel is scanned two-dimensionally with excitation light such as laser light to emit photostimulated luminescence which, in turn, is read photoelectrically to yield an image signal. Then, an image reproduced on the basis of the image signal is output as the radiation image of the subject, typically to a display device such as CRT or on a recording material such as a photosensitive material.

The phosphor panel is typically prepared by the following method: Powder of a stimulable phosphor is dispersed in a solvent containing a binder and other necessary ingredients to make a coating solution, which is applied to a support panel made of glass or a resin, with the applied coating being subsequently dried.

Also known are phosphor panels which are prepared by forming a phosphor layer on a support through vacuum film deposition (vapor-phase film deposition) such as vacuum deposition or sputtering (see JP 2789194 B and JP 5-249299 A). The phosphor layer formed by the vacuum film deposition has superior characteristics in that it is formed in vacuo and hence has low impurity levels and that being substantially free of any ingredients other than the stimulable phosphor as exemplified by a binder, the phosphor layer has not only small scatter in performance but also features very highly efficient luminescence.

However, the phosphor layer and in particular the layer made of an alkali halide-based stimulable phosphor and having excellent characteristics are highly hygroscopic and readily absorb moisture even in a normal temperature and humidity environment. As a result, deterioration of the photostimulated luminescence characteristics, that is, sensitivity and deterioration of the crystallinity of the stimulable phosphor (for example, the crystal columnarity is impaired in an alkali halide-based stimulable phosphor having a columnar structure) may reduce the sharpness of a reproduced image.

In order to solve such a problem, it is known to seal the phosphor layer with a gas barrier film having moisture barrier properties that serves as a moisture-proof protective film. Various types of gas barrier films that may be appropriately used for the moisture-proof protective film have also been provided in order to produce phosphor panels that can be used for a long term in good condition.

The gas barrier film is usually obtained by forming a gas barrier layer on a sheet-like flexible substrate film. A silicon dioxide layer (hereinafter referred to simply as SiO₂ layer) is known as the gas barrier layer.

For example, JP 2004-93560 A discloses a phosphor panel that uses as its moisture-proof protective film a gas barrier film obtained by forming on a substrate film a gas barrier layer (protective layer) composed of three sublayers including an aluminum oxide sublayer, a silicon oxide sublayer and an aluminum oxide sublayer.

In the case where a silicon oxide layer used for the gas barrier layer is formed by magnetron sputtering using argon gas as the sputtering gas, the film porosity and the average pore size are known to decrease with decreasing argon gas pressure and silicon oxide layer thickness to impart excellent gas barrier properties to the silicon oxide layer (see “Journal of the Ceramic Society of Japan”, 112[6] 338-341 (2004)).

It is also known that a silicon oxide layer having excellent barrier properties is obtained when 180 to 200 oxygen atoms and 40 to 80 carbon atoms are used with respect to 100 silicon atoms, and the infrared absorption based on the Si—O—Si stretching vibration is found at 1045 cm⁻¹ to 1060 cm⁻¹ and the infrared absorption based on the Si—CH₃ stretching vibration at 1274 ±4 cm⁻¹ (see JP 2002-361774 A)

### SUMMARY OF THE INVENTION

Gas barrier films having excellent gas barrier properties can be obtained by using the SiO₂ layer as mentioned above.

However, the gas barrier properties, that is, the moisture barrier properties required for the moisture-proof protective film of a phosphor panel are extremely high, and sufficiently high moisture barrier properties cannot be achieved even in a gas barrier film using the SiO₂ layer for the gas barrier layer unless the gas barrier layer is of a multilayered structure as described in JP 2004-93560 A.

Therefore, the time and cost are involved in producing the gas barrier layer of the multilayered structure, and in the case where higher moisture barrier properties are required, the number of film deposition processes is increased, and the time and cost are involved in each film deposition process.

The present invention has been accomplished in order to solve the aforementioned problems and a first object of the present invention is to provide a gas barrier film that can exhibit particularly excellent gas barrier properties, that is, moisture barrier properties even if the gas barrier film has a gas barrier layer of monolayer structure, and that can exhibit sufficiently high moisture barrier properties for a phosphor layer even when the gas barrier film is used, for example, as the moisture-proof protective film of a phosphor panel, thus enabling the phosphor panel obtained to be used for a long term.

A second object of the present invention is to provide a stimulable phosphor panel that uses the gas barrier film.

A third object of the present invention is to provide a method of producing the gas barrier film described above.

In order to achieve the first object, the present invention provides a gas barrier film comprising:

a substrate film; and

a gas barrier layer formed on the substrate film, wherein the gas barrier layer is an inorganic compound layer that is made of an inorganic compound having a grain size of 3 nm to 20 nm and has grain boundaries at intervals of 1 nm to 20 nm.

In the present invention, the inorganic compound is preferably at least one selected from the group consisting of silicon oxides, silicon nitrides, silicon oxynitrides, metal oxides, metal nitrides, metal oxynitrides, and diamondlike carbon.

In the present invention, the inorganic compound is preferably silicon dioxide.

In the present invention, the inorganic compound layer is preferably a layer made of the inorganic compound that is formed by impedance controlled reactive sputtering at a film deposition pressure of 0.01 Pa to 0.13 Pa.

In order to achieve the second object, the present invention provides a stimulable phosphor panel comprising:

a substrate;

a stimulable phosphor layer formed on the substrate; and

a gas barrier film with which the stimulable phosphor layer is covered and sealed,

wherein the gas barrier film comprises:
a substrate film; and
a gas barrier layer formed on the substrate film, and
   wherein the gas barrier layer is an inorganic compound layer that is made of an inorganic compound having a grain size of 3 nm to 20 nm and has grain boundaries at intervals of 1 nm to 20 nm.

In order to achieve the third object, the present invention provides a method of producing a gas barrier film comprising the steps of:

preparing a substrate film; and

performing impedance controlled reactive sputtering on the substrate film at a film deposition pressure of 0.01 Pa to 0.13 Pa to form a gas barrier layer on the substrate film to thereby produce the gas barrier film.

In the present invention, a discharge voltage of the impedance controlled reactive sputtering is preferably in a range of 480 V to 660 V.

In the present invention, the impedance controlled reactive sputtering is preferably performed in a transition region.

In the present invention, the gas barrier layer is preferably made of an inorganic compound.

In the present invention, the impedance controlled reactive sputtering is preferably performed using silicon and oxygen gas for a target and a reactive gas, respectively.

By using a gas barrier layer which is an inorganic compound layer that is made of an inorganic compound having a grain size of 3 nm to 20 nm and has grain boundaries at intervals of 1 nm to 20 nm, there can be provided a gas barrier film that can exhibit particularly excellent gas barrier properties, that is, moisture barrier properties even if the gas barrier film has a gas barrier layer of monolayer structure, and that can exhibit sufficiently high moisture barrier properties for a phosphor layer even when the gas barrier film is used, for example, as the moisture-proof protective film of a phosphor panel, thus enabling the phosphor panel obtained to be used for a long term, as well as its production method. A stimulable phosphor panel in which deterioration due to humidity is hardly confirmed can also be provided by sealing a stimulable phosphor layer formed on a substrate with the gas barrier film having excellent moisture barrier properties.

### BRIEF DESCRIPTION OF THE DRAWINGS

FIG. 1 is a sectional view showing an embodiment of a gas barrier film of the present invention;

FIG. 2 is a conceptual view showing a film running type sputtering device appropriate to implement a method of producing the gas barrier film according to the present invention;

FIG. 3 is a sectional view showing an embodiment of a stimulable phosphor panel of the present invention in which the gas barrier film of the present invention is used for the moisture-proof protective film; and

FIGS. 4A and 4B are sectional views showing other embodiments of the stimulable phosphor panel of the present invention.

### DETAILED DESCRIPTION OF THE PREFERRED EMBODIMENTS

The gas barrier film and its production method, and the stimulable phosphor panel according to the present invention will be described below in detail with reference to preferred embodiments shown in the attached drawings.

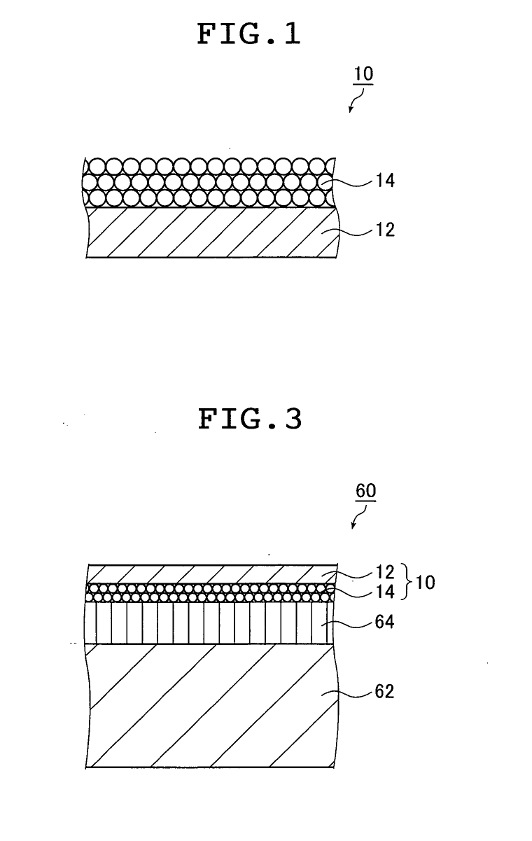

FIG. 1 shows a conceptual sectional view of a gas barrier film of the present invention.

A gas barrier film 10 of the present invention shown in FIG. 1 basically includes a substrate film 12 and a gas barrier layer 14.

In the illustrated embodiment, the gas barrier layer 14 is directly formed on the substrate film 12. However, this is not the sole case of the present invention but the gas barrier film 10 may optionally have layers (films) having various functions such as an adhesion layer formed between the gas barrier layer 14 and the substrate film 12, and a protective layer formed on the adhesion layer. Alternatively, the gas barrier film 10 may have another layer that serves as a gas barrier layer.

There is no particular limitation on the substrate film 12 in the gas barrier film 10 of the present invention, and various flexible films are usable.

Exemplary films that may be used include those made of polyethylene terephthalate (PET), polyethylene naphthalate (PEN), triacetyl cellulose (TAC), polyether sulfone (PES), polyarylate (PAr) and norbornene, and those having excellent mechanical strength and dimension stability are preferable.

Of these, it is particularly preferable to use a film made of PET in the case where the gas barrier film 10 is used as a moisture-proof protective film for preventing the phosphor layer of a stimulable phosphor panel (hereinafter referred to simply as a “phosphor panel”) from absorbing moisture.

The thickness of the substrate film 12 is not particularly limited but a thickness which is not unnecessarily large and allows a sufficient strength to be maintained in an application of the substrate film 12 in combination with the gas barrier layer 14 to be described later may be determined as appropriate.

The gas barrier layer 14 in the gas barrier film 10 of the present invention is an inorganic compound layer which is made of an inorganic compound having a grain size of 3 nm to 20 nm and which has grain boundaries at intervals of 1 nm to 20 nm.

The inventors of the present invention have made intensive studies about a gas barrier layer having excellent gas barrier properties and as a result found that the grain size of an inorganic compound, the interval between adjacent grain boundaries in the layer, and the balance between the two factors are very important in the gas barrier layer formed of the inorganic compound through vapor-phase film deposition. As a result of the studies, the inventors have also found that, when the gas barrier layer is formed of an inorganic compound having a grain size of 3 nm to 20 nm and has grain boundaries at invervals of 1 nm to 20 nm, both the factors can have a synergistic effect to achieve particularly excellent gas barrier properties, whereby a gas barrier film having excellent gas barrier properties can be obtained even if the gas barrier film has a gas barrier layer of monolayer structure.

The gas barrier film can be successfully used in applications for which very high moisture barrier properties are required, as exemplified by the moisture-proof protective film of the above-mentioned phosphor panel even if the gas barrier film has a gas barrier layer of monolayer structure. Therefore, a high quality phosphor panel that does not cause any deterioration of the properties due to moisture absorption for a long term can be realized by using the gas barrier film in the phosphor panel.

As mentioned above, the gas barrier layer 14 in the gas barrier film 10 of the present invention is an inorganic compound layer which is made of an inorganic compound having a grain size of 3 nm to 20 nm and which has grain boundaries at invervals of 1 nm to 20 nm.

When the inorganic compound of which the gas barrier layer is formed has a grain size of less than 3 nm, sufficiently high gas barrier properties cannot be achieved because the individual grains have reduced moisture barrier properties.

When the grain size exceeds 20 nm, the grain boundaries cannot be formed at predetermined intervals and sufficiently high gas barrier properties cannot be achieved.

When the gas barrier layer has the grain boundaries at intervals of less than 1 nm, the grains are rather closely packed to cause difficulties in the grain arrangement, whereby voids are readily formed in the layer and consequently sufficiently high gas barrier properties cannot be achieved.

On the other hand, when the gas barrier layer has the grain boundaries at intervals exceeding 20 nm, sufficiently high gas barrier properties cannot be achieved even if the grain size satisfies the above condition.

In the present invention, the term “grain size” as used herein refers to a size of each grain made of an inorganic compound and the term “grain boundary” is used to represent the distance between adjacent grains made of an inorganic compound.

More specifically, an arbitrary region of a target film is first taken with an atomic force microscope (AFM) to obtain an image. As for the grain size, twenty grains arbitrarily positioned on the image are selected and their diameters (maximum diameters in the case where the grains are not spherical) are measured. The arithmetic mean of the twenty measurements is regarded as the grain size. As for the interval between adjacent grain boundaries, arbitrary twenty grains that are not in contact with each other are selected and the shortest one of the distances on the image between each selected grain and its surrounding grains is measured. The arithmetic mean of the twenty measurements is regarded as the interval between adjacent grain boundaries.

There is no particular limitation on the inorganic compound of which the gas barrier layer 14 in the gas barrier film 10 of the present invention is made, and various inorganic compounds can be used.

Specific examples of the inorganic compound include silicon oxides represented by SiOx, silicon nitrides represented by SiNx, silicon oxynitrides represented by SiOxNy, metal oxides represented by AlOx or TiOx, metal oxynitrides represented by AlOxNy, diamondlike carbon and metal nitrides. Among these, silicon dioxide (SiO₂) is more preferable.

The gas barrier film 10 of the present invention can be produced by forming the gas barrier layer 14 on the surface of the substrate film 12 by means of any known vapor-phase film deposition technique with the film forming conditions adjusted so as to satisfy the conditions of the grain size and the grain boundary interval. However, the gas barrier film 10 of the present invention is preferably produced by the method of producing the gas barrier film 10 of the present invention to be described below.

According to the method of producing the gas barrier film 10 of the present invention, the gas barrier layer 14 is formed by impedance controlled reactive sputtering at a film deposition pressure of 0.01 Pa to 0.13 Pa.

As is well known, impedance control is performed in reactive sputtering to perform sputtering at a discharge voltage kept constant by adjusting the flow rate of a reactive gas such as oxygen gas while the voltage applied to the cathode is kept constant.

The impedance control is originally known as a method of controlling the film deposition voltage that was developed to enhance the film deposition rate. The inventors of the present invention have made intensive studies about a gas barrier layer having excellent gas barrier properties and as a result found that a dense gas barrier layer having excellent gas barrier properties can be formed at a film deposition pressure of not more than 0.2 Pa. However, a film deposition pressure of not more than 0.2 Pa makes discharge and hence the state of film deposition unstable. In this regard, the inventors of the present invention have found that the impedance controlled reactive sputtering enables stable discharge even at a reduced film deposition pressure, and in addition, the impedance controlled reactive sputtering at a film deposition pressure set to 0.01 Pa to 0.13 Pa allows a dense inorganic compound layer satisfying the above conditions to be consistently produced at a high film deposition rate. An excellent gas barrier layer having particularly excellent gas barrier properties and satisfying the above conditions can be obtained by forming a SiO₂ layer on the substrate film 12 through the impedance controlled reactive sputtering that is performed at the film deposition pressure as defined above using silicon and oxygen gas for the target and reactive gas, respectively.

That is, the production method of the present invention is capable of consistently producing gas barrier films exhibiting particularly excellent gas barrier properties at a high film deposition rate in a high yield even if the gas barrier film has a gas barrier layer of monolayer structure as described above.

As mentioned above, a reduced film deposition pressure during the formation of the SiO₂ layer and a smaller film thickness enable reduced pore size and porosity to achieve higher gas barrier properties (see Journal of the Ceramic Society of Japan, supra).

However, the film deposition pressure disclosed therein is 0.25 Pa to 1.5 Pa in terms of the pressure of argon gas and is hence much higher than that in the present invention, so the gas barrier layer of the present invention cannot be formed at the film deposition pressure that falls within the above range. There is no disclosure or suggestion about the structure of the SiO₂ layer (more specifically the grain size and the grain boundary interval).

In the method of producing the gas barrier film of the present invention, the impedance controlled reactive sputtering is performed at a film deposition pressure of 0.01 Pa to 0.13 Pa as mentioned above.

Without the impedance control, a stable discharge cannot be achieved at any film deposition pressure falling within the above range.

Various known means can be used to adjust the amount of reactive gas to be used for the impedance control. A piezoelectric valve is preferably used because it has a high responsivity and can keep the discharge voltage constant even at a low film deposition pressure.

In the production method of the present invention, the discharge voltage is not limited to any particular value, but is preferably 480V to 660V and more preferably 600V to 620V.

The reactive sputtering is preferably performed in the transition region in that the film deposition rate can be increased to achieve a high yield and the amount of reactive gas can be decreased to reduce the film deposition pressure (the film deposition pressure can be appropriately maintained). However, the impedance controlled reactive sputtering can be consistently performed in the transition region at the film deposition pressure as defined above by setting the discharge voltage within the range defined above.

Sputtering is performed under the above conditions, whereby consistent film deposition can be achieved while inconveniences are obviated.

The material used for the target may also be selected as appropriate according to the gas barrier layer to be formed. On the other hand, the reactive gas may also be selected as appropriate according to the gas barrier layer to be formed. As mentioned above, it is preferable in the present invention to form a layer made of SiO₂ for the gas barrier layer by using silicon and oxygen for the target and reactive gas, respectively.

In addition, various sputtering processes such as RF sputtering and DC pulse sputtering can be used in the present invention for the impedance controlled reactive sputtering, and DC pulse sputtering is advantageously used.

There is no other limitation in the method of producing the gas barrier film of the present invention and the speed at which the substrate film is transported, the film deposition rate in the gas barrier layer, the electric power for film deposition, the amount of reactive gas introduced and the like may be determined as appropriate according to the required yield and film deposition material used.

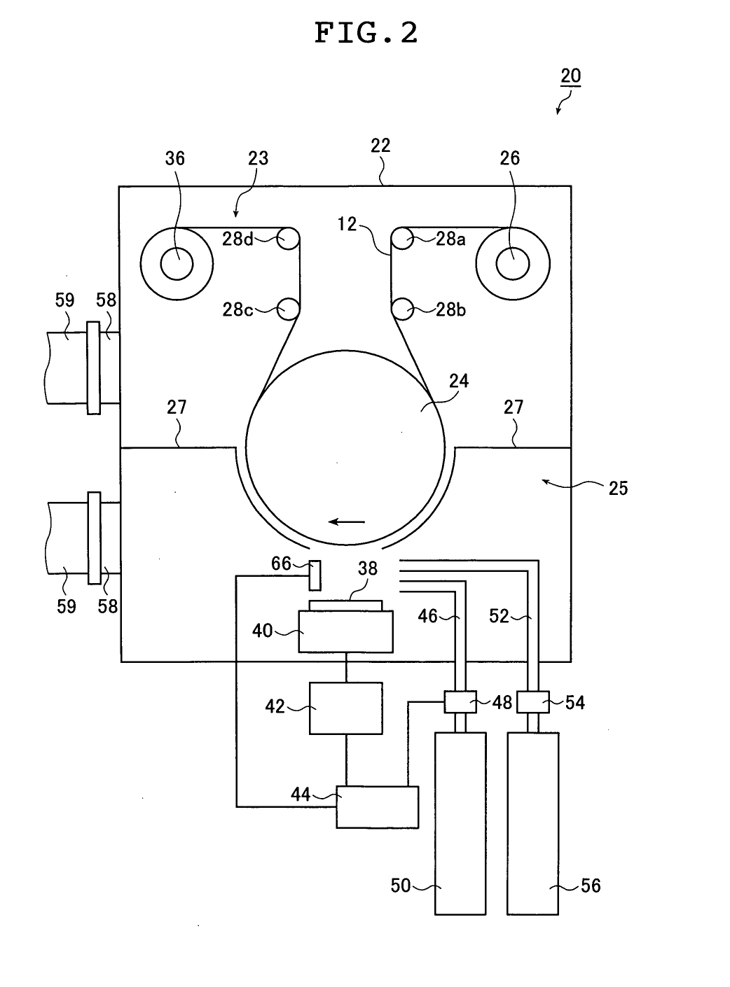

FIG. 2 conceptually shows a film running type sputtering device appropriate to implement the method of producing the gas barrier film according to the present invention.

This sputtering device is not the sole device used to produce the gas barrier film of the present invention. This sputtering device may not be exclusively used to implement the method of producing the gas barrier film of the present invention.

A sputtering device 20 shown in FIG. 2 is used to form the gas barrier layer 14 by a sputtering technique on the surface of the substrate film 12 in the shape of an elongated band such as a plastic film.

As shown in FIG. 2, the sputtering device 20 includes a vacuum chamber 22, two vacuum pumps 59 for reducing the internal pressure of the vacuum chamber 22, and a substrate transport system 23 and a film deposition system 25 formed in the vacuum chamber 22. The gas barrier layer 14 is formed on the surface of the substrate film 12 by the impedance controlled reactive sputtering while the substrate film 12 is transported in the longitudinal direction.

The vacuum pumps 59 are used to reduce the internal pressure of the vacuum chamber 22 through air outlets 58 and various known types that are used in common sputtering devices and the like can be employed.

In the illustrated case, the substrate transport system 23 and the film deposition system 25 within the vacuum chamber 22 are separated from each other by a partition wall 27 (and a drum 24 to be described later) in a substantially airtight manner, and the two vacuum pumps 59 are provided for the respective systems.

The substrate transport system 23 transports the substrate film 12 in the shape of an elongated band in the longitudinal direction and includes a feed roll 26, the drum 24, a take-up roll 36 and guide rolls 28a to 28d.

The feed roll 26 has a roll of the substrate film 12 loaded therein and rotates to feed the substrate film 12 toward the drum 24. The take-up roll 36 winds up the substrate film 12 on which the gas barrier layer has been formed into a roll.

The drum 24 rotates so that its rotation axis coincides with a direction perpendicular to the longitudinal direction (i.e., transport direction) of the substrate film 12. The substrate film 12 on which the gas barrier layer is to be formed is wrapped around the lateral surface of the drum 24, which rotates to transport the wrapped substrate film 12 longitudinally while the substrate film 12 is regulated so as to pass through a predetermined film deposition position.

The guide rolls 28a to 28d guide the substrate film 12 along a predetermined transport path. At least one of them is preferably capable of tension control to thereby apply a predetermined tension to the substrate film 12.

In the illustrated case, the substrate film 12 is transported along the predetermined transport path as follows: The substrate film 12 is fed from the feed roll 26, guided by the guide rolls 28a, 28b, wrapped around the drum 24, and guided by the guide rolls 28c, 28d to reach the take-up roll 36.

On the other hand, the film deposition system 25 includes a cathode 40 for holding a target 38, a discharge power source 42 for applying a discharge voltage to the cathode 40, a reactive gas supply pipe 46, a reactive gas flow rate adjusting unit 48, a reactive gas cylinder 50, a discharge gas supply pipe 52, a discharge gas flow controller 54, a discharge gas cylinder 56 and a controller 44.

As shown in FIG. 2, measuring means 66 for measuring the discharge voltage is provided above the cathode 40 of the film deposition system 25 at a position where the measuring means 66 does not interfere with the film deposition process.

The cathode 40 holds the target 38 so that the target 38 faces the lower end of the drum 24. There is no particular limitation on the discharge power source 42 applying a discharge voltage to the cathode 40, but a DC pulse power source is preferably used.

The partition wall 27 is opened at the portion where the drum 24 faces the target 38 (cathode 40).

The reactive gas such as oxygen gas is supplied from the reactive gas cylinder 50 through the reactive gas supply pipe 46 into the vacuum chamber 22 (film deposition system 25) after its flow rate is adjusted in the reactive gas flow rate adjusting unit 48. As mentioned above, the piezoelectric valve is preferably used in the reactive gas flow rate adjusting unit 48 in terms of its responsivity or the like.

The discharge gas such as argon gas is supplied from the discharge gas cylinder 56 through the discharge gas supply pipe 52 into the vacuum chamber 22 (film deposition system 25) after its flow rate is adjusted in the discharge gas flow controller 54. A mass flow controller or other unit used in common sputtering devices may be used for the discharge gas flow controller 54.

The controller 44 controls the discharge voltage from the discharge power source 42 and the reactive gas flow rate adjusted in the reactive gas flow rate adjusting unit 48.

When the impedance controlled reactive sputtering is performed in the illustrated device, the controller 44 receives feedback on the discharge voltage measurement results obtained by the measuring means 66 and controls the reactive gas flow rate, that is, the reactive gas flow rate adjusting unit 48 so that the discharge voltage has a predetermined value.

Any known instrument may be used for the measuring means 66.

Next, an embodiment in which the gas barrier film of the present invention is produced by using the sputtering device 20 having the above-mentioned configuration will be described below.

The substrate film 12 is loaded in the feed roll 26. The substrate film 12 pulled out of the feed roll 26 is sequentially passed along the guide rolls 28a and 28b, the drum 24, and the guide rolls 28c and 28d to be wound up by the take-up roll 36. Once the vacuum chamber 22 is closed, the vacuum pumps 59 are driven to reduce the internal pressure of the vacuum chamber 22 to a predetermined value.

After the internal pressure of the vacuum chamber 22 has reached a predetermined value, the substrate film 12 is transported at a predetermined speed while the discharge gas is introduced into the vacuum chamber 22 with its flow rate controlled with the discharge gas flow controller 54.

The transport speed of the substrate film 12 during the film deposition is not particularly limited but may be determined as appropriate according to the film deposition rate required for the substrate film 12 to be treated, the output power on the cathode 40 and the like.

Thereafter, the vacuum chamber 22 is maintained at a predetermined pressure and electric power is supplied from the discharge power source 42 to the cathode 40 to perform presputtering.

After the presputtering, the reactive gas whose flow rate has been controlled with the reactive gas flow rate adjusting unit 48 is introduced through the reactive gas supply pipe 46 into the vacuum chamber 22 and a predetermined value of voltage is applied to the cathode 40.

The discharge voltage within the vacuum chamber 22 is thus maintained at a predetermined value, after which the amounts of the discharge gas and reactive gas to be supplied are reduced and the film deposition pressure is controlled until the vacuum chamber 22 has the ultimate film deposition pressure, thereby forming the gas barrier layer 14 on the substrate film 12.

In this process, the discharge voltage during the film deposition is measured with the measuring means 66 that is disposed above the cathode 40 of the film deposition system 25 at a position where the measuring means 66 does not interfere with the film deposition process. In the illustrated case, the measuring means 66 is disposed above the cathode 40 on its left side. The controller 44 receives feedback on the measurement results and controls the reactive gas flow rate, that is, the reactive gas flow rate adjusting unit 48 so that the discharge voltage has a predetermined value, thus keeping the discharge voltage during the film deposition constant.

The substrate film 12 on which the gas barrier layer 14 has been formed, in other words, the gas barrier film is guided by the guide rolls 28c and 28d to be wound up by the take-up roll 36.

The gas barrier film 10 of the present invention can be used in various applications, but is particularly appropriate to use as a moisture-proof protective layer for preventing the phosphor layer of the phosphor panel from absorbing moisture.

FIG. 3 shows an example of a phosphor panel 60 of the present invention in which the gas barrier film of the present invention is used for the moisture-proof protective film.

In the phosphor panel 60 of the present invention, a phosphor layer 64 is formed on the surface of a substrate 62 and the phosphor layer 64 is covered with the gas barrier film 10 (moisture-proof protective film) with the gas barrier layer 14 disposed on the side of the phosphor layer 64 to thereby seal the phosphor layer 64 between the substrate 62 and the gas barrier film 10.

There is no particular limitation on the type of the substrate 62 used in the phosphor panel 60 of the present invention as long as the substrate 62 has rigidity and various types as used in common phosphor panels are usable.

Exemplary types include plastic films such as cellulose acetate film, polyester film, polyethylene terephthalate film, polyamide film, polyimide film, triacetate film, and polycarbonate film; glass plates made of quartz glass, alkali-free glass, soda glass, heat-resistant glass (e.g., Pyrex™) and the like; metal sheets such as aluminum sheet, iron sheet, copper sheet and chromium sheet; and sheets obtained by forming a coating layer such as a metal oxide layer on the surfaces of such metal sheets.

There is no particular limitation on the stimulable phosphor of which the phosphor layer 64 is formed and various phosphors can be used.

Preferred exemplary stimulable phosphors that may be used include alkali halide-based stimulable phosphors represented by the general formula “M^{I}X.aM^{II}X′₂.bM^{III}X″₃:cA” as disclosed by JP 61-72087 A. In this formula, M^{I} represents at least one element selected from the group consisting of Li, Na, K, Rb, and Cs. M^{II} represents at least one divalent metal selected from the group consisting of Be, Mg, Ca, Sr, Ba, Zn, Cd, Cu, and Ni. M^{III} represents at least one trivalent metal selected from the group consisting of Sc, Y, La, Ce, Pr, Nd, Pm, Sm, Eu, Gd, Tb, Dy, Ho, Er, Tm, Yb, Lu, Al, Ga, and In. X, X′, and X″ each represent at least one element selected from the group consisting of F, Cl, Br, and I. A represents at least one element selected from the group consisting of Eu, Tb, Ce, Tm, Dy, Pr, Ho, Nd, Yb, Er, Gd, Lu, Sm, Y, Tl, Na, Ag, Cu, Bi, and Mg, 0≦a<0.5, 0≦b<0.5, and 0≦c<0.2.

Alkali halide-based stimulable phosphors in which M^{I} contains at least Cs, X contains at least Br, and A is Eu or Bi are preferred and stimulable phosphors represented by the general formula “CsBr:Eu” are more preferred particularly in that they have excellent photostimulated luminescence characteristics and the effect of the present invention is advantageously obtained.

Layers exhibiting various functions such as a reflective layer and an adhesion layer may be formed between the substrate 62 and the phosphor layer 64.

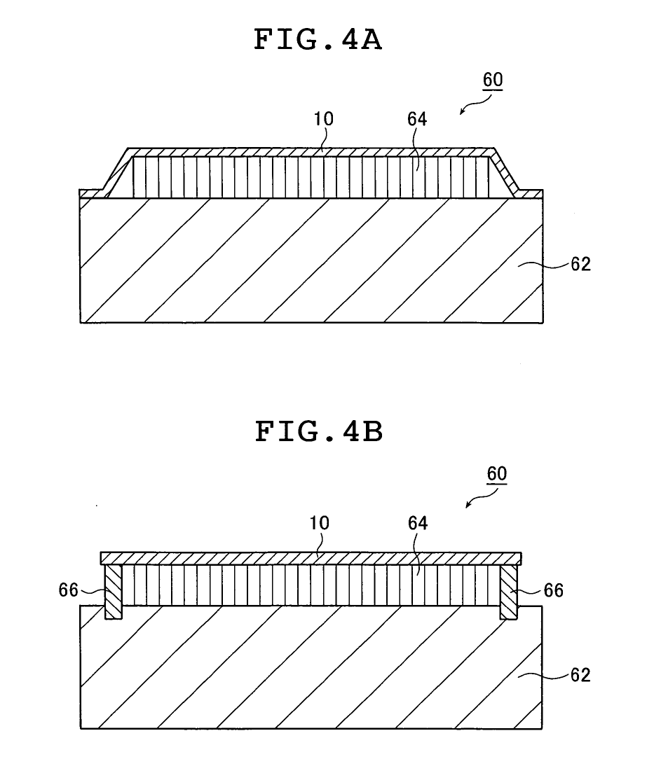

In the phosphor panel 60 of the present invention, the gas barrier film 10 may be adhered to the substrate 62 on the periphery of the phosphor layer 64 to seal the phosphor layer 64 with the gas barrier film 10, as shown in FIG. 4A, or alternatively the gas barrier film 10 may be adhered to the upper surface of a wall portion 66 provided so as to surround the phosphor layer 64 to thereby seal the phosphor layer 64 with the gas barrier film 10, as shown in FIG. 4B.

An adhesion layer may be used to bond the gas barrier film 10 and the phosphor layer 64 together in order to prevent delamination of the gas barrier film 10 and enhance the strength of the phosphor panel 60 of the present invention.

The present invention has been basically as described above.

While the gas barrier film, its production method, and the stimulable phosphor panel using the gas barrier film according to the present invention have been described above in detail, the invention is by no means limited to the foregoing embodiments and it should be understood that various improvements and modifications can of course be made without departing from the scope and spirit of the invention.

### EXAMPLES

The invention will be described below in further detail by reference to specific examples of the present invention which follow.

### Example 1

The sputtering device 20 shown in FIG. 2 was used to perform film deposition.

A PET film with a thickness of 57 μm was used for the substrate film 12. As shown in FIG. 2, the substrate film 12 pulled out of the feed roll 26 was sequentially passed along the guide rolls 28a, 28b, the drum 24, and the guide rolls 28c, 28d to be wound up by the take-up roll 36.

A silicon target serving as the target 38 was attached to the cathode 40.

The vacuum pumps 59 were driven to start evacuation of the vacuum chamber 22 until the internal pressure of the vacuum chamber 22 reached 4×10⁻⁴ Pa. Thereafter, the substrate film 12 was transported in the longitudinal direction at a speed of 0.2 m/min and argon gas serving as the discharge gas was introduced into the vacuum chamber 22. In this process, the discharge gas flow controller 54 was used to adjust the flow rate of the argon gas and the discharge gas was introduced into the vacuum chamber 22 through the discharge gas supply pipe 52.

After the discharge gas has been introduced into the vacuum chamber 22, its internal pressure was adjusted to 0.27 Pa and 7 kW of electric power for film deposition was supplied from the discharge power source 42 to perform presputtering.

Oxygen gas as the reactive gas was introduced into the vacuum chamber 22 10 minutes after the start of the presputtering. In this process, the oxygen gas was introduced through the reactive gas supply pipe 46 while its flow rate was adjusted in the reactive gas flow rate adjusting unit 48.

After the oxygen gas has been introduced, the discharge voltage was controlled to be maintained at 610 V. Thereafter, the amounts of the argon gas and oxygen gas to be supplied were reduced and the film deposition pressure was ultimately decreased to 0.03 Pa to form a SiO₂ layer with a thickness of 100 nm on the PET film.

During the film deposition, the discharge voltage was measured with the measuring means 66 and the flow rate of the oxygen gas was adjusted in the reactive gas flow rate adjusting unit 48 according to the measurement results (based on the feedback) so that the discharge voltage was maintained at 610 V (impedance control was performed).

The surface of the SiO₂ layer formed on the PET film by the procedure as described above was observed with an atomic force microscope (AFM). The grain size of the grains in the SiO₂ layer was 10 nm and the grain boundary interval in the SiO₂ layer was 15 nm.

In addition, a water vapor transmission rate tester (PERMATRAN-W3/33 from MOCON, Inc.) was used to measure the water vapor transmission rate of the gas barrier film of Example 1 in an environment of 40° C. and 90% RH according to the method of JIS K7129 B. The gas barrier film had a water vapor transmission rate of 0.4 g/[m²·day] and achieved excellent gas barrier properties.

### Comparative Example 1

A SiO² layer with a thickness of 100 nm was formed on the PET film by the same procedure as in Example 1 except that the substrate film 12 was fed at a speed of 0.3/min and the ultimate film deposition pressure was set to 0.27 Pa.

The surface of the SiO₂ layer was observed. As a result, the grain size of the grains in the SiO₂ layer was 25 nm and the grain boundary interval in the SiO₂ layer was 30 nm.

The water vapor transmission rate of the gas barrier film in Comparative Example 1 was also measured in the same manner as in Example 1. The gas barrier film had a water vapor transmission rate of 10.0 g/[m²·day] and did not achieve sufficient gas barrier properties.

The results obtained above clearly show the effectiveness of the present invention.

What is claimed is:

1. A gas barrier film comprising:
a substrate film; and
a gas barrier layer formed on said substrate film,
wherein said gas barrier layer is an inorganic compound layer that is made of an inorganic compound having a grain size of 3 nm to 20 nm and has grain boundaries at intervals of 1 nm to 20 nm.

2. The gas barrier film according to claim 1, wherein said inorganic compound is at least one selected from the group consisting of silicon oxides, silicon nitrides, silicon oxynitrides, metal oxides, metal nitrides, metal oxynitrides, and diamondlike carbon.

3. The gas barrier film according to claim 1, wherein said inorganic compound is silicon dioxide.

4. The gas barrier film according to claim 1, wherein said inorganic compound layer is a layer made of said inorganic compound that is formed by impedance controlled reactive sputtering at a film deposition pressure of 0.01 Pa to 0.13 Pa.

5. A stimulable phosphor panel comprising:
a substrate;
a stimulable phosphor layer formed on the substrate; and
a gas barrier film with which said stimulable phosphor layer is covered and sealed,
wherein said gas barrier film comprises:
a substrate film; and
a gas barrier layer formed on said substrate film, and
wherein said gas barrier layer is an inorganic compound layer that is made of an inorganic compound having a grain size of 3 nm to 20 nm and has grain boundaries at intervals of 1 nm to 20 nm.

6. The stimulable phosphor panel according to claim 5, wherein said inorganic compound is at least one selected from the group consisting of silicon oxides, silicon nitrides, silicon oxynitrides, metal oxides, metal nitrides, metal oxynitrides, and diamondlike carbon.

7. The stimulable phosphor panel according to claim 5, wherein said inorganic compound is silicon dioxide.

8. The stimulable phosphor panel according to claim 5, wherein said inorganic compound layer is a layer made of said inorganic compound that is formed by impedance controlled reactive sputtering at a film deposition pressure of 0.01 Pa to 0.13 Pa.

9. A method of producing a gas barrier film comprising the steps of:
preparing a substrate film; and
performing impedance controlled reactive sputtering on said substrate film at a film deposition pressure of 0.01 Pa to 0.13 Pa to form a gas barrier layer on said substrate film to thereby produce said gas barrier film.

10. The method of producing the gas barrier film according to claim 9, wherein a discharge voltage of said impedance controlled reactive sputtering is in a range of 480 V to 660 V.

11. The method of producing the gas barrier film according to claim 9, wherein said impedance controlled reactive sputtering is performed in a transition region.

12. The method of producing the gas barrier film according to claim 9, wherein said gas barrier layer is made of an inorganic compound.

13. The method of producing the gas barrier film according to claim 9, wherein said impedance controlled reactive sputtering is performed using silicon and oxygen gas for a target and a reactive gas, respectively.
